(19) United States
(12) Patent Application Publication
(10) Pub. No.: US 2026/0269161 A1
(43) Pub. Date: Sep. 10, 2026

(54) TRIAXIAL RELAY

(71) Applicant: Keithley Instruments, LLC, Solon, OH (US)

(72) Inventor: Wayne C. Goeke, Hudson, OH (US)

(21) Appl. No.: 19/543,666

(22) Filed: Feb. 18, 2026

Related U.S. Application Data
(60) Provisional application No. 63/767,438, filed on Mar. 5, 2025.

(51) Int. Cl. H01H 50/02

(52) U.S. Cl. CPC H01H 50/02

(57) ABSTRACT

A triaxial relay includes a center conductor having a first portion and a second portion, the first portion and the second portion separated when not energized and positioned to come into contact when the relay is energized, an enclosure coaxial with the center conductor containing the first portion and the second portion of the center conductor, an outer shield coaxial with the center conductor, a first guard coaxial with the first portion of the center conductor between the first portion of the center conductor and the outer shield, a second guard coaxial with the second portion of the center conductor between the second portion of the center conductor and the outer shield, and a bobbin coaxial with the center conductor outside of the outer shield.

### CROSS-REFERENCE TO RELATED APPLICATIONS

This disclosure is a non-provisional of and claims benefit from U.S. Provisional Application No. 63/767,438, titled “TRIAXIAL RELAY,” filed on Mar. 5, 2025, the disclosure of which is incorporated herein by reference in its entirety.

### TECHNICAL FIELD

This disclosure relates to test and measurement instruments, and more particularly to a triaxial relay.

### BACKGROUND

Triaxial cables generally comprise a center conductor, a guard, and a shield arranged concentrically along a cable. The guard is generally continuous along the length of the cable. These types of cables are used in testing semiconductor devices. Many semiconductor devices are tested with both low frequency, meaning low current, and high frequency signals. Being able to switch these signals while also preventing current leakage, present challenges.

### BRIEF DESCRIPTION OF THE DRAWINGS

FIG. 1 shows an end view of a triaxial relay with a guard.

FIG. 2 shows an embodiment of a triaxial relay with a guard.

FIG. 3 shows an alternative embodiment of a triaxial relay with a guard.

FIG. 4 shows an embodiment of a guarded form C triaxial relay.

### DETAILED DESCRIPTION

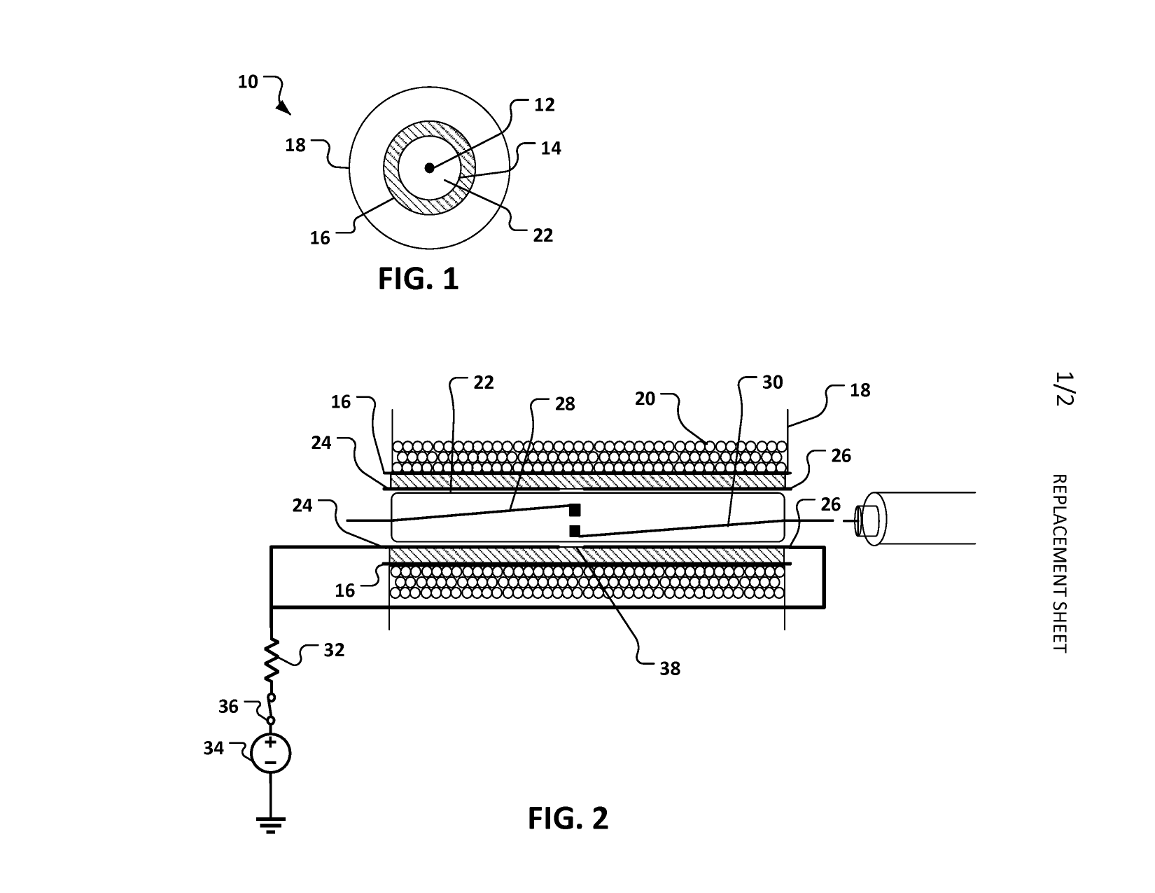

The present disclosure involves a triaxial relay with a guard or pair of guards to reduce leakage from the signal with an outer shield to provide an alternating-current (AC) ground. FIG. 1 shows an end view of an embodiment of a relay with a guard or pair of guards to reduce leakage from the signal with an outer shield to provide an AC ground. From the end view, the triaxial relay 10 looks similar to a triaxial cable. The center conductor 12 is surrounded by an enclosure 22. The enclosure 22 may comprise glass, ceramic, or other materials. The center conductor 12 runs coaxially through the relay, and the layers shown in the following figures run coaxially as well, unless otherwise indicated. Guard 14 is coaxial to the center conductor, as is the outer shield 16. In the embodiment shown here, guard 14 is between the outer shield 16 and the enclosure 22. Coil bobbin 18 encases the elements of the coil 20 that lie between the outer shield 16 and the external surface of the relay

FIG. 2 shows a side view of an embodiment of a triaxial relay. The coil bobbin 18 contains the elements of the coil 20. FIG. 2 is a side view of a dissection of the triaxial relay, so the elements are symmetrically arranged around the center conductor 12 of FIG. 1. In this view, one can see that the center conductor 12 from FIG. 1 comprises two portions, 28 and 30. The two portions 28 and 30 are separated by a gap in a state in which the triaxial relay is unenergized. When the coil 20 is energized, the flow of current generates a magnetic field that causes the first portion 28 and second portion 30 to connect to each other. The first guard 24, shown on both top and bottom, is coaxial to the first portion of the center conductor, also referred to as a reed. The second guard 26 is coaxial to the second portion of the center conductor 30. A gap 38 exists between the two guards to provide electrical isolation between the two guards. Situations may exist in which one portion of the center conductor may be driven to a different potential than the other, or one may be driven and the other not driven. The outer shield 16 runs coaxially to center conductor, and may be separated from the guards 24 and 26 by a dielectric

In one embodiment of operation of the triaxial relay, guards 24 and 26 are driven to the same potential 34 as the center conductor at lower frequencies, meaning lower currents. The guards 24 and 26 prevent or mitigate the leakage from the center conductor 12. A characteristic impedance exists between the center conductor 12 and the guards 24 and 26, and between the guards 24 and 26 and the outer shield 16.

For example, if there is an impedance of 50 ohms between the center conductor 12 and the guards 24 and 26, and an impedance of 50 ohms between the guards 24 and 26 and the outer shield 16, the total characteristic impedance of the relay is 100 ohms. A resistance shown as resistor 32 is selected to be much larger than the total characteristic impedance, typically an order of magnitude or larger. At higher frequencies, the guards 24 and 26 float in the electromagnetic field generated by the higher frequency signal traveling in the center conductor, resulting in them having no effect on the signal in the center conductor 12.

In an alternative embodiment, the guards 24 and 26 may be disconnected from the potential 34 by switch 36, allowing guards 24 and 26 to float in the electromagnetic field generated by signals in the center conductor 12. The resistor may also be a resistive element internal to the triaxial relay, as disclosed in US Patent No. 7,568,946, issued August 4, 2009, incorporated herein in its entirety.

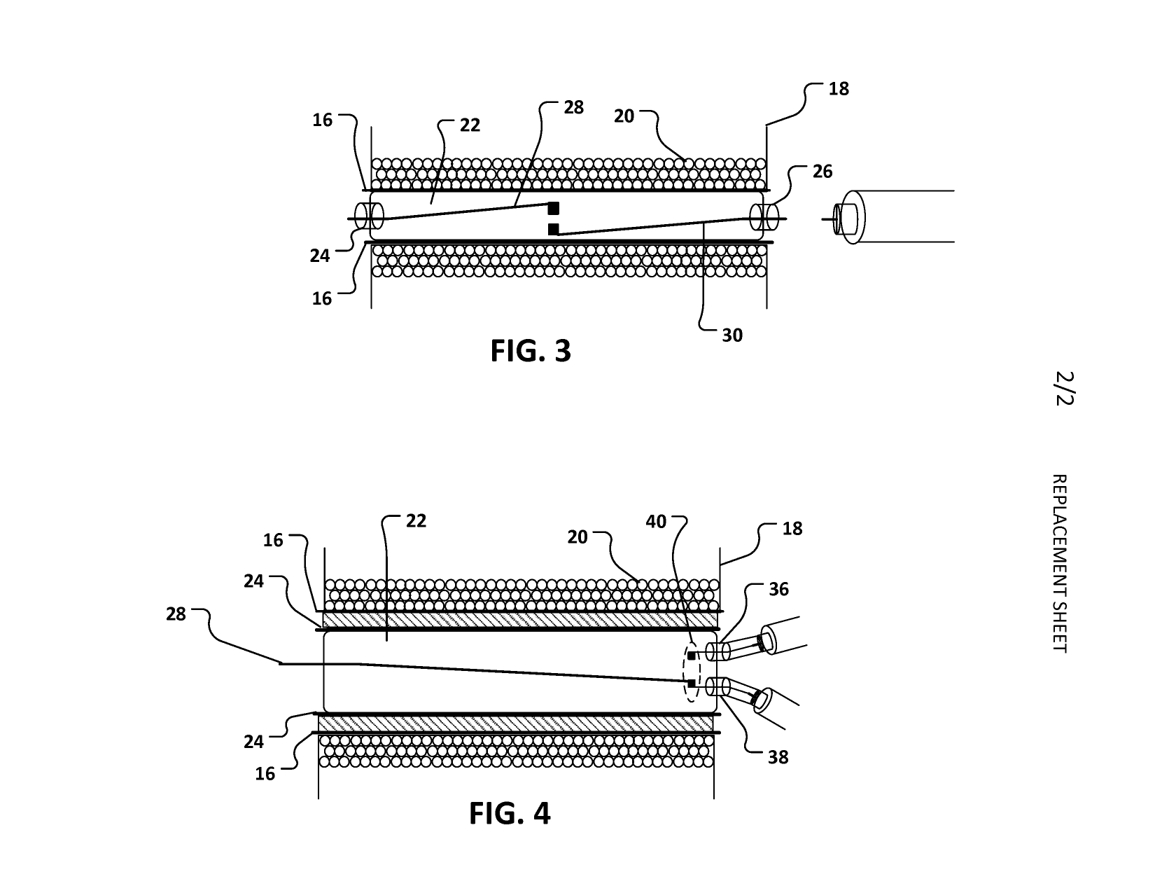

FIG. 3 shows an embodiment of a triaxial relay having a reed-enclosure built with guarded feed-through. In this embodiment, the guards 24 and 26 are referred to as being between the center conductor and the outer coaxial surface of the enclosure 22, to differentiate it from the previous embodiment. In both embodiments, the guards lie between the center conductor and the outer shield. This embodiment provides guarded direct feed through. The enclosure is sealed around the center conductor portions 28 and 30.

The embodiments are not limited to single position center conductor relays in which the first portion 28 of the center conductor connects to the second portion 30 of the center conductor or not. FIG. 4 illustrates an example of the present disclosure as a guarded form C relay, in which the relay has a double-pole, single-throw switch. The first guard 24 runs the length of the first portion 28 of the center conductor 12. The first portion 28 of the center conductor 12 connects to a first position of the switch 40, with a second guard 38. For purposes of discussion, the first position will be referred to as the non-energized position, with the understanding that either position could be either the energized or non-energized position.

When energized, the first portion 28 then changes position and connects to the second position with third guard 36. In this manner, the first portion 28 of the center portion connects to one or the other position, rather than being either separated or connected.

In this manner, a guarded triaxial relay reduces leakage from the signal in the center conductor to provide an AC ground to overcome the controlled-characteristic impedance between the center conductor and outer shield

Aspects of the disclosure may operate on a particularly created hardware, on firmware, digital signal processors, or on a specially programmed general-purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a triaxial relay, comprising: a center conductor having a first portion and a second portion, the first portion and the second portion separated when not energized and positioned to come into contact when the relay is energized; an enclosure coaxial with the center conductor containing the first portion and the second portion of the center conductor; an outer shield coaxial with the center conductor; a first guard coaxial with the first portion of the center conductor between the first portion of the center conductor and the outer shield; a second guard coaxial with the second portion of the center conductor between the second portion of the center conductor and the outer shield; and a bobbin coaxial with the center conductor outside of the outer shield.

Example 2 is the triaxial relay of Example 1, wherein the first guard and the second guard are between the enclosure and the outer shield.

Example 3 is the triaxial relay of either of Examples 1 or 2, wherein the first guard is between the first portion of the center conductor and an outer surface of the enclosure, and the second guard is between the second portion of the center conductor and the outer surface of the enclosure.

Example 4 is the triaxial relay of Example 3, wherein the triaxial relay has guarded feed through.

Example 5 is the triaxial relay of any of Examples 1 through 4, further comprising a voltage potential selectively connectable to the first guard and the second guard.

Example 6 is the triaxial relay of Example 5, further comprising a switch to allow the voltage potential to be disconnected from the first guard and the second guard.

Example 7 is the triaxial relay of any of Examples 1 through 6, further comprising at least one resistance connected to the first guard and the second guard, wherein the at least one resistance has a value higher than a characteristic impedance between the center conductor and the outer shield such that the center conductor floats in an electromagnetic field caused by a signal in the center conductor.

Example 8 is the triaxial relay of any of Examples 1 through 7, wherein the enclosure comprise one of either glass or ceramic.

Example 9 is the triaxial relay of any of Examples 1 through 8, further comprising a gap between the first guard and the second guard.

Example 10 is a triaxial relay, comprising: a center conductor; an enclosure coaxial with the center conductor; an outer shield coaxial with the center conductor; a double-pole, single-throw switch having a first position and a second position, the center conductor being connected to the first position and configured to connect to the second position when the relay is energized; a first guard coaxial with the center conductor between the enclosure and the outer shield; a second guard coaxial with the first position; and a third guard coaxial with the second position.

Example 11 is the triaxial relay of Example 10, wherein the enclosure comprises one of either glass or ceramic.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

1. A triaxial relay, comprising:
a center conductor having a first portion and a second portion, the first portion and the second portion separated when not energized and positioned to come into contact when the relay is energized;
an enclosure coaxial with the center conductor containing the first portion and the second portion of the center conductor;
an outer shield coaxial with the center conductor;
a first guard coaxial with the first portion of the center conductor between the first portion of the center conductor and the outer shield;
a second guard coaxial with the second portion of the center conductor between the second portion of the center conductor and the outer shield; and
a bobbin coaxial with the center conductor outside of the outer shield.

2. The triaxial relay as claimed in claim 1, wherein the first guard and the second guard are between the enclosure and the outer shield.

3. The triaxial relay as claimed in claim 1, wherein the first guard is between the first portion of the center conductor and an outer surface of the enclosure, and the second guard is between the second portion of the center conductor and the outer surface of the enclosure.

4. The triaxial relay as claimed in claim 3, wherein the triaxial relay has guarded feed through.

5. The triaxial relay as claimed in claim 1, further comprising a voltage potential selectively connectable to the first guard and the second guard.

6. The triaxial relay as claimed in claim 5, further comprising a switch to allow the voltage potential to be disconnected from the first guard and the second guard.

7. The triaxial relay as claimed in claim 1, further comprising at least one resistance connected to the first guard and the second guard, wherein the at least one resistance has a value higher than a characteristic impedance between the center conductor and the outer shield such that the center conductor floats in an electromagnetic field caused by a signal in the center conductor.

8. The triaxial relay as claimed in claim 1, wherein the enclosure comprise one of either glass or ceramic.

9. The triaxial relay as claimed in claim 1, further comprising a gap between the first guard and the second guard.

10. A triaxial relay, comprising:
a center conductor;
an enclosure coaxial with the center conductor;
an outer shield coaxial with the center conductor;
a double-pole, single-throw switch having a first position and a second position, the center conductor being connected to the first position and configured to connect to the second position when the relay is energized;
a first guard coaxial with the center conductor between the enclosure and the outer shield;
a second guard coaxial with the first position; and
a third guard coaxial with the second position.

11. The triaxial relay as claimed in claim 10, wherein the enclosure comprises one of either glass or ceramic.
